(19) United States
(12) Patent Application Publication
(10) Pub. No.: US 2024/0265365 A1
(43) Pub. Date: Aug. 8, 2024

(54) A MODULAR ARTICLE

(71) Applicant: SITA B.V., The Hague (NL)

(72) Inventors: Mathieu Eduard KEIZER, The Hague (NL); Alexandros Vangelis PLIAKIS, The Hague (NL); Swen Van KLAARBERGEN, The Hague (NL); Bas BRUINING, Rijswijk (NL); Vincent LAAGLAND, Den Haag (NL)

(21) Appl. No.: 18/640,942

(22) Filed: Apr. 19, 2024

Related U.S. Application Data
(63) Continuation of application No. PCT/EP2022/079305, filed on Oct. 20, 2022.

(30) Foreign Application Priority Data
Oct. 21, 2021 (GB) 2115154.3

(51) Int. Cl. G06Q 20/18

(52) U.S. Cl. CPC G06Q 20/18

(57) ABSTRACT

There is provided a modular article 100 comprising a core module 101 including: a back panel 103 and an internal compartment 105 configured to house one or more internal modules and one or more modular devices 107. The modular article 100 also comprises: a door 301 to the internal compartment coupled to the core module 101 and being configurable to comprise at least one aperture 303 configured to facilitate use of the one or more modular devices 107 in the internal compartment 105; and an interface portion coupled to the core module 101, the interface portion having a first portion 201 and a second portion 203, each of the first portion 201 and the second portion 203 being configured to receive one or more modular interface devices 205.

### CROSS-REFERENCE TO RELATED APPLICATION

This application is a continuation of International Patent Application No. PCT/EP2022/079305, filed Oct. 20, 2022, and entitled “A MODULAR ARTICLE,” which claims the benefit of and priority to United Kingdom Application No. 2115154.3, filed Oct. 21, 2021, and entitled “A MODULAR ARTICLE,” each of which are incorporated by reference in their entirety herein.

### FIELD OF THE INVENTION

The present invention relates to a modular article, and a method of modifying a modular article. In particular, the invention relates to a modular kiosk, and more particularly to a modular self-service kiosk.

### BACKGROUND

Articles such as kiosks provide functionality to users in, for example, a transportation hub such as an airport.

Existing kiosks include various components, some of which may be housed within the kiosk. These kiosks are built with the existing components in mind. In other words, hardware connections and mountings for, for example, computer modules, displays, and dispensing means such as printers or cash dispensers are specifically designed or selected for those components. Such kiosk designs suffer from a number of drawbacks.

Both hardware and software development for kiosks is relatively fast. When new technology is developed, whether it be a single component of a kiosk or many, existing kiosks must be replaced in their entirety, or at least significantly modified even after the kiosk is implemented or installed at, for example, a transportation hub. For example, to modify a kiosk to replace a component, significant dismantling and rebuilding must take place to replace even a single upgraded component. This is both inefficient and expensive.

In addition, kiosk components will often require servicing. In existing kiosks, it is often inconvenient to provide such servicing due to their non-versatile design.

### SUMMARY OF THE INVENTION

Inventors of the present invention have appreciated the need for a “future-proof” kiosk capable of facilitating the efficient upgrade and servicing of its hardware and software components in order to keep up with technology development without the need to replace or significantly modify the kiosk. In particular, the inventors of the present invention have appreciated that a kiosk, and particularly a self-service kiosk such as an airport self-service kiosk, can be provided that is configured to receive various modules and devices, each of which can be conveniently removed, replaced, or serviced. In doing so, as certain elements of self-service kiosks are designed or improved upon, any new technology or module can be incorporated into the existing modular kiosk without replacing an entire kiosk. This is advantageous in terms of convenience, cost, and for environmental reasons.

The invention is defined by the independent claims to which reference should now be made. Optional features are set forth in the dependent claims.

According to an aspect of the invention, there is provided a modular article comprising: a core module including: a back panel and an internal compartment configured to house one or more internal modules and one or more modular devices; a door to the internal compartment coupled to the core module and being configurable to comprise at least one aperture configured to facilitate use of the one or more modular devices in the internal compartment; and an interface portion coupled to the core module, the interface portion having a first portion and a second portion, each of the first portion and the second portion being configured to receive one or more modular interface devices. In other words, embodiments of the present disclosure provide a modular article configured to receive, mount, or house one or more modules or devices either within the interior, or on the exterior of the article, in order to provide desired functionality for an owner or user of the article, whilst allowing the article to be modified, upgraded, or serviced with any new or alternative modules if desired. That is, the modular article according to embodiments of the present invention is conveniently configured to be fully customizable, upgradeable, and/or serviceable.

The core module and the interface portion may comprise a plurality of connection means, the one or more modular devices and the one or more modular interface devices being configured to be releasably securable to the plurality of connection means. The connection means may be any suitable connection means that facilitates releasable attachment of said module or device to the modular article. For example, the attachment means may comprise connection holes such as screw or bolt holes to allow a module or device to be releasably attached with screws or bolts. Where the module or device comprises electrical components, the connection means may comprise means for electrical connection to the modular article.

The core module may further comprise side panels forming sides of the internal compartment. The side panels may be side weldments. That is, at least some of the core module may be formed by a single weldment or single piece of material. The core module may comprise the back panel and the side panels or side weldments, such as two side panels or side weldments. The back panel may be coupled to the side panels, forming the core module. The back panel and side weldments may define the internal compartment configured to house the one or more internal modules and the one or modular devices. In other words, the space between the back panel and the side panels may define the internal compartment.

Each of the side panels may comprise at least one releasable attachment point configured to releasably attach a side panel layer to one or each of the side panels. A side panel layer may be, for example, an advertisement panel or branding panel. By providing the releasable attachment point, an advertisement panel or branding panel (for example) may conveniently and easily be changed. Attachment of the side panel layer may be made more secure by grooves or protrusions on each of the side panels. That is, a groove or protrusion may be provided at or towards the base of one or both of the side panels The side panel layer may slot into the groove or between the side panel and the protrusion, and then subsequently be connected to the releasable attachment point. The side panel layer may be arranged such that, when inserted into the groove or protrusion, the groove or protrusion cannot be seen externally.

The modular article may further comprise a sidecar module releasably attachable to one of the side panels. The sidecar module may be configured to receive one or more modular devices and/or one or more modular interface devices. That is, the sidecar module may be considered an extension of the modular article. This allows additional modules or devices to be incorporated into the functionality of the modular article when such modules or devices may not have been able to fit into the existing article arrangement due to size or space limitations. The releasable attachment between the sidecar module and the modular article may comprise an electrical connection to facilitate use of one or more electrical modules or devices at the sidecar. The sidecar may be releasably attached to either side of the modular article, and a plurality of sidecar modules may be attached to the article.

The core module may further comprise cross members arranged between the side panels, the cross members comprising at least some of the plurality of connection means. The cross members may comprise an elongate portion and a tab at each end of the elongate portion, each tab being substantially perpendicular to the elongate portion, the tabs facilitating connection to the side panels. The cross members may also be formed as the same piece of material as the side panels. The back panel may be coupled to the side panels via the cross members to form the core module.

The door may be configurable to comprise the at least one aperture by arranging one or more removable insert portions to provide an aperture configuration. The insert portions may be made of metal. The desired aperture configuration may correspond to a configuration of modular devices housed in the internal compartment. For example, the one or more modular devices housed in the internal compartment may comprise one or more dispensing means. The one or more dispensing means may comprise one or more of: a boarding pass printer; a bag tag printer; and a receipt printer. Where the internal compartment houses modular devices in the form of printers, such as two printers, an aperture configuration may be provided to facilitate dispensing from the printers. The aperture configuration may then be conveniently adjusted to correspond to the devices or printers in the internal compartment as they are added, removed, or replaced. In some embodiments, the configurable aperture is the only modular or customizable aspect of the door.

Different dispensing means may be of different sizes, allowing for different configurations of different dispensing means. For example, the internal compartment may be configured to house a plurality of bag tag printers or receipt printers, such as three of these printers, but a boarding pass printer may be larger. Therefore, in some embodiments, where the internal compartment houses a boarding pass printer, the internal compartment may only house one of a bag tag printer or receipt printer. In some embodiments, the maximum number of printers the internal compartment may house may be three printers. It will be understood that such an arrangement is exemplary, and any suitable configuration of dispensing means may be used as desired by a customer or user.

The first portion may comprise an interface device shelf configured to receive the one or more modular interface devices, the device shelf being releasably coupled to the core module. The device shelf may be releasably coupled to the core module with a locking mechanism. The device shelf may be interchangeable with one or more device shelves having different configurations to facilitate different configurations of modular interface devices. The first portion may be nearly, but not, horizontal. For example, the first portion may be arranged at an angle of 81.5 degrees to the vertical. By enabling replacement of the device shelf in its entirety, an entirely different configuration of devices may be provided on the device shelf of the modular article. Each differently configured device shelf may have one or more differently configured apertures configured to receive a corresponding modular interface device. In some embodiments, a device shelf may comprise at least one aperture having an aperture cover, which can later be removed and an interface device can be installed, thereby allowing convenient customization in the future without having an open aperture in the device shelf.

The one or more modular interface devices may non-exhaustively comprise one or more of: a passport scanner; a display such as an LCD display; payment means; a card reader; a pin pad such as for a payment card chip reader; a near field communication (NFC) reader; a barcode reader such as an LSR barcode reader; a fingerprint scanner; a lighting device such as a light emitting diode (LED); one or more cameras such as a border kiosk camera; directional buttons; selection buttons; and an audio jack input. The first portion or device shelf may comprise one or more of these interface devices. One or more of the interface devices may be configured to meet ADA requirements, for example an ADA compliant passport scanner. The card reader may be a payment card reader, or may be for authorization such as for a system login. The LEDs may comprise directional arrows configured to illuminate, directing a user to interact with a particular device on the device shelf such as a fingerprint scanner. Alternatively or in addition, the light may comprise an indicator light, configured to indicate that part of the module needs servicing or maintenance. The lighting device may also comprise a camera flash. The display may be an information display, for example to display instructions to a user interacting with the article, or to display branding or advertisement information.

In some embodiments, the second portion may comprise one or more modular interface devices, for example a display such as an LCD display, and a camera. The display may be a touch screen display. The second portion may comprise a face portion and a hinge mechanism configured to allow opening and closing of the face portion, and the modular interface devices may be mounted to the face portion. In some embodiments, one or more modular interface devices may be mounted to the face portion (such as the display) and one or more other modular interface devices may be mounted to the second portion, not on the face portion (such as one or more cameras). For example, the display may be mounted to the face portion and coupled to the core module via the hinge mechanism, allowing the display to be pivoted or opened away from the modular article about the hinge, thereby allowing access behind the display. In this way, the display or other installed modular interface devices may be conveniently serviced or replaced. The hinge mechanism may be located at or towards the base of the face portion. Advantageously, the face portion may be secured in a closed position using one or more connection means such as quick release screws, allowing for fast, convenient access to behind the face portion. The second portion may comprise at least one camera not mounted to the face portion, such as a camera configured for facial recognition. Such a camera may be mounted to the second portion, such as above the display and above the top of the face portion. The second portion may be substantially upright, but not necessarily vertical, for example to allow a user of the modular article to easily view a display on the second portion.

The second portion may also be extended. For example, the second portion of the interface portion may be configured to receive an extension portion, which may extend functionality of the interface portion. In some embodiments, such an extension portion would extend the interface portion vertically upwards. The extension portion may additionally be configured to receive one or more modular interface devices. In some embodiments, the extension portion may receive one or more of a camera device, a display, and an external camera flash. In addition, the position of the extension portion may be adjustable such that the position of a device, for example a camera, may be adjusted. Alternatively or in addition, differently configured extension portions may be coupled to the modular device, providing for interface devices at different locations, such as at different heights to meet the particular needs or a customer or user of the modular article.

The modular article may further comprise a base portion coupled to the core module, the base portion being configured to support the core module and to receive one or more base modules. That is, the base portion can extend the functionality of the modular article by facilitating connection or installation of yet further modules or devices. For example, the one or more base modules may include one or more of: a battery pack; a mobility module; a stability plate; and an adapter module. The battery pack may comprise a battery configured to provide power to the modular article, removing the need for a connection to an external power source. The mobility module may comprise means for conveniently relocating the modular article, such as one or more wheels driven by a motor. The stability plate may be a support plate having a surface area larger than that of the base of the modular article, thereby providing increased stability to a modular article at rest, meeting relevant stability requirements. The adapter module may enable the modular article to adapt to a legacy connection point. Differently configured base portions may be alternatively coupled to the modular article. For example, differently configured base portions may adjust the height of the modular article at rest. The base portion may be configured to meet ADA requirements, such as ADA height requirements.

The one or more internal modules may comprise a processor configured to identify and control the one or more internal modules, the one or more modular devices, and the one or more modular interface devices. The one or more internal modules may comprise a one or more of: computer modules, computer devices, or power modules. The power module may comprise an uninterruptible power supply (UPS), or an IP power bar. The modular article may comprise a computer device configured to control operation of the devices or modules currently installed in the modular article. The internal modules are housed in the internal compartment and may be coupled to the kiosk. For example, the internal modules may be mounted to the base portion, inside the core module's internal compartment. The internal modules may be coupled to the back panel. For example, the internal modules may comprise a power module, and said power module may be coupled to a power switch on the back panel. The back panel may also comprise one or more of a power distribution board, an LED controller, and an adapter, one or more of which may be coupled to one or more internal modules.

In some embodiments, the modular article may be of similar dimensions to a typical self-service kiosk. In some embodiments however, the modular article may be slimmer (have a smaller width) than such an article, for example having half the width of a typical self-service kiosk. This may depend on the needs of a customer or user. For example, where fewer modules and devices are required, a slimmer article may be provided which advantageously takes up less physical space. In some embodiments, the modular article having a smaller width than a typical kiosk may comprise, at maximum, two printers. The modular article having a smaller width may have a display arranged in a portrait orientation. In contrast, in some embodiments, a modular article having similar dimensions to a typical self-service kiosk and being wider than the slimmer modular article may comprise, at maximum, three printers. The modular article having typical dimensions may have a display arranged at a landscape orientation.

According to another aspect of the present invention, there is provided a modular article comprising: a core module including: a back panel and an internal compartment configured to house one or more internal modules and one or more modular devices, and an interface portion coupled to the core module, the interface portion having a first portion and a second portion, each of the first portion and the second portion being configured to receive one or more modular interface devices. In other words, a modular article may be provided without the door having configurable apertures according to embodiments described above. Whilst it will be understood that such an article may have a door having configurable apertures as described herein, such a modular article may not necessarily comprise said door, and may instead, for example, have a panel coupled to the core module.

According to another aspect of the present invention, there is provided a method of modifying a modular article comprising: providing a modular article according to any embodiment as described herein; and mounting or installing one or more of: an internal module, a modular device, and a modular interface device to the modular article. The method may also comprise modifying, replacing, upgrading, or servicing one or more of the internal module, the modular device, and the modular interface device.

The core module and the interface portion may comprise a plurality of connection means, and the mounting or installing comprises releasably securing one or more of: the modular device and the modular interface device to at least some of the connection means.

The core module may further comprise side panels forming sides of the internal compartment. Each of the side panels may comprise at least one releasable attachment point, and the method may further comprise releasably attaching one or more of: a sidecar module; and a side panel layer to one or each of the side panels. The method may further comprise mounting or installing one or more modular devices and/or one or more modular interface devices to the sidecar module.

The core module may further comprise cross members arranged between the side panels, the cross members comprising at least some of the plurality of connection means, and the method further comprises mounting or installing the one or more modular devices to the plurality of connection means of the cross members.

The method may further comprise arranging one or more insert portions at the least one aperture to provide an aperture configuration.

The first portion may comprise an interface device shelf releasably coupled to the core module, and the method may further comprise mounting or installing the one or more modular interface devices to the interface device shelf. The device shelf may be releasably coupled to the core module with a locking mechanism.

The method may further comprise replacing the device shelf with a differently configured device shelf configured to facilitate a different configuration of modular interface devices.

The one or more modular devices housed in the internal compartment may comprise one or more dispensing means. The one or more dispensing means may comprise one or more of: a boarding pass printer; a bag tag printer; and a receipt printer.

The second portion may comprise a face portion and a hinge mechanism configured to allow opening and closing of the face portion, and the method may further comprise opening the face portion via the hinge to modify or install one or more modular interface devices. The one or more modular interface devices may comprise a display coupled to the core module via the hinge mechanism.

The method may further comprise coupling a base portion to the core module. The method may further comprise mounting or installing one or more base modules to the base portion. The one or more base modules may comprise one or more of: a battery pack; a mobility module; a stability plate; and an adapter module.

The one or more internal modules may comprise a processor configured to identify and control the one or more internal modules, the one or more modular devices, and the one or more modular interface devices.

The one or more internal modules may comprise one or more computer modules. The one or more modular interface devices may comprise one or more of: a passport scanner; a display such as an LCD display; payment means; a card reader; a pin pad such as for a payment card chip reader; a near field communication (NFC) reader; a barcode reader such as an LSR barcode reader; a fingerprint scanner; a lighting device such as a light emitting diode (LED); one or more cameras such as a border kiosk camera; directional buttons; selection buttons; and an audio jack input.

Embodiments of the present invention have been described. It will be appreciated that variations and modifications may be made to the described embodiments within the scope of the present invention.

### BRIEF DESCRIPTION OF THE DRAWINGS

The invention will now be described in more detail, by way of example, with reference to the accompanying drawings, in which:

FIG. 1A is a schematic diagram of a front view of a modular article according to aspects of the present invention;

FIG. 1B is a schematic diagram of a perspective view of a modular article according to aspects of the present invention;

FIG. 2A is a diagram of a modular article according to aspects of the present invention;

FIG. 2B is a diagram of a modular article according to aspects of the present invention;

FIG. 3A is a schematic diagram of a door to the internal compartment of a modular article according to aspects of the present invention;

FIG. 3B is a schematic diagram of a modular article according to aspects of the present invention;

FIG. 4A is a schematic diagram of a modular article with interchangeable device shelves according to aspects of the present invention;

FIG. 4B is a schematic diagram of a device shelf coupled to a modular article with a locking mechanism according to aspects of the present invention;

FIG. 5A is a schematic diagram of a modular article illustrating interchangeable side panel layers according to aspects of the present invention;

FIG. 5B is a schematic diagram of a side weldment coupled to a base portion according to aspects of the present invention;

FIG. 6 is a schematic diagram of a modular article according to aspects of the present invention;

FIG. 7 is a schematic diagram of a modular article having an extension portion according to aspects of the present invention;

FIG. 8A is a schematic diagram of a modular article having a base portion according to aspects of the present invention; and

FIG. 8B is a schematic diagram of a modular article having a base portion according to aspects of the present invention.

Like features are denoted by like reference numerals.

### DETAILED DESCRIPTION

The following description is of a kiosk application for use by any one of a number of merchants, passengers or users of, for example, airlines, but it will be understood that this application is only exemplary and other applications of the invention will be also be discussed.

For example, embodiments of the invention may also find application in any environment, where users interact with a terminal or computing device. Exemplary environments may include: airport kiosks, parking, ground transportation, gates and check-in areas; buses, hotel check-in/out areas, kiosks and room based ordering services; government services; security, license provisioning, park passes, vendor provisioning; shopping mall, multi-merchant stores or markets, retail order and checkout; car rental kiosks; telephone card dispensing; food court ordering and pickup; takeout and food ordering systems; train ticketing and check-in; cruise terminals; and taxi stands. Embodiments of the invention may have general application in the transportation or travel industries and moreover in any environment where infrastructure is used by a number of different users in, for example, the shipping, rail, and road transportation industries.

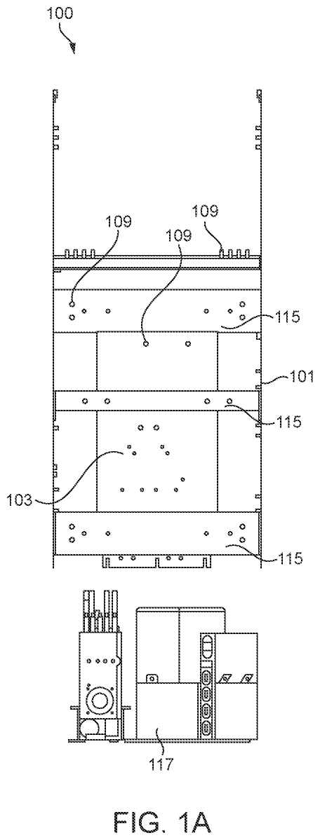

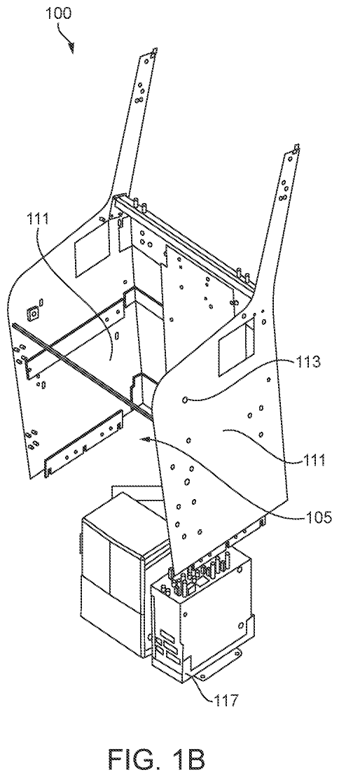

An example device will now be described with reference to FIGS. 1 to 8B.

FIGS. 1A and 1B illustrate a modular article 100 according to aspects of the present invention. In this example, the modular article 100 is a kiosk, and specifically a self-service kiosk suitable for a transportation hub such as an airport. The modular article 100 comprises a core module 101. The core module 101 comprises a back panel 103, as well as side panels which in this example are side weldments 111. Extending between the side weldments 111 are a plurality of cross members 115, which each comprise an elongate portion extending between the side weldments 111 as well as tab portions coupled to the side weldments 111. In this example, the tab portions are coupled to the side weldments with bolts.

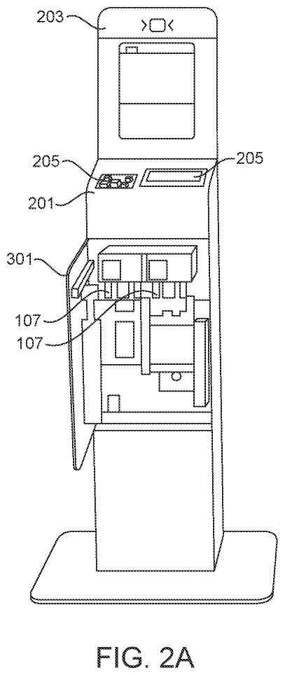

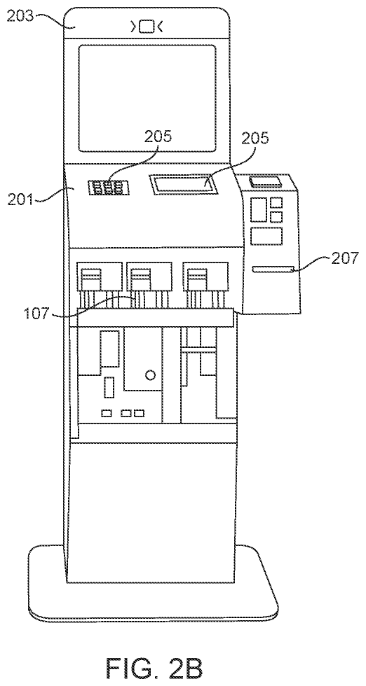

In this example, the back panel 103 is coupled to the cross members 115 (and therefore side weldments 111) by means of bolts. It will be appreciated that any suitable method of coupling may be used. Explained in more detail below with reference to FIG. 2A and 2B, the core module 101 also comprises an internal compartment 105 configured to house one or more internal modules 117 and one or more modular devices 107. The internal compartment comprises the space defined by the side weldments 111 and the back panel 103. That is, one or more internal modules 117 and one or more 107 modular devices may be housed in this space. The core module comprises a plurality of connection means 109, which in this example are holes configured to provide coupling with bolts. The modular devices may be installed or mounted in the internal compartment using the connection means 109.

Similarly to the rest of the core module 101, the back panel 103 comprises connection means in the form of holes for mounting or installing devices or modules. The internal modules 117 may include, for example, computer modules, power modules, or electronic modules. For example, the internal modules 117 may include a computer having a processor configured to identify and control the modules or devices installed in the modular article 100. The internal modules 117 may also comprise electrical devices such as a battery pack or power adapter for connection with a mains power supply. The internal modules are coupled to the kiosk, and in this example, to the base of the kiosk explained more below. Where an internal module is an electrical module, the connection means at which the internal modules are coupled to the kiosk may comprise electrical connections for providing electrical connection with the modular article 100. In this example, the internal modules 117 comprise an uninterrupted power supply, a computer device, and an IP power bar.

Conveniently, depending on the needs of a particular customer or user, different configurations of modules and devices may be installed into the modular article, providing the desired functionality. What is more, as technology advances or requirements change, modules and devices may be advantageously updated or replaced without needing to replace the entire article.

The side weldments 111 also comprise releasable attachment points 113 for coupling a sidecar module to the modular article 100, explained in more detail with reference to FIG. 2B.

FIGS. 2A and 2B illustrate modular articles for example as shown in FIGS. 1A and 1B, but with modules and devices installed.

In particular, modular devices 107 have been installed. The modular devices 107 are dispensing means, which can be boarding pass printers, bag tag printers, or receipt printers. Depending on the needs of a customer or user, differing configurations of printers may be desired.

In the embodiment illustrated in FIG. 2A, a relatively slim modular article is provided. That is, FIG. 2B illustrates an embodiment having dimensions typical of an airport self-service kiosk, particularly in relation to its width. The embodiment illustrated in FIG. 2A, however, has a smaller width of approximately half that of the embodiment illustrated in FIG. 2B.

The width of the modular article affects the modules and devices that may be installed. For example, in this example, the modular article of FIG. 2A has two printers 107 installed, which here are a bag tag printer and a receipt printer. The printers are mounted within the internal compartment by the connection means of the core module. The modular article of FIG. 2B has a larger width and therefore has three printers 107 installed, which here comprise two bag tag printers and a receipt printer. It will be appreciated, however, that any suitable configuration of printers may be installed.

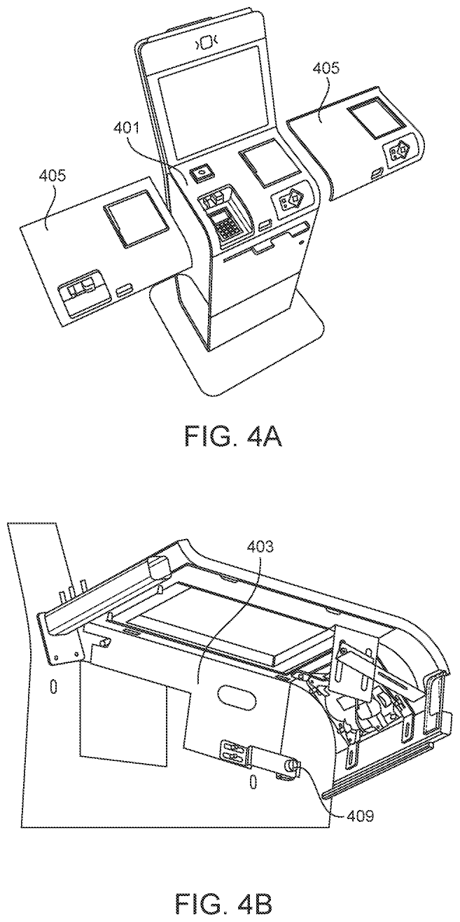

The modular articles of FIGS. 2A and 2B also each comprise an interface portion coupled to the core module. The interface portion has a first portion 201 and a second portion 203, each of which is configured to receive one or more modular interface devices. Generally, the modular interface devices comprise devices with which a user of the modular article may interact. Such devices may comprise: a passport scanner; a display such as an LCD display; payment means; a card reader; a pin pad such as for a payment card chip reader; a near field communication (NFC) reader; a barcode reader such as an LSR barcode reader; a fingerprint scanner; a lighting device such as a light emitting diode (LED); one or more cameras such as a border kiosk camera; directional buttons; selection buttons; and an audio jack input, for example. In this example, each of the second portions 203 kiosks illustrated in FIGS. 2A and 2B comprise a camera and a display. In the relatively slimmer kiosk of FIG. 2A, the display is at a portrait orientation. In the relatively wider kiosk of FIG. 2B, the display is at a landscape orientation. Explained in more detail below with reference to FIGS. 4A and 4B, the first portion comprises a device shelf having interface devices 205.

The modular article of FIG. 2B also comprises a sidecar module 207. The sidecar module 207 is releasably attached to the core module via the releasable attachment points 113, and is configured to receive one or more modular devices or interface devices. Broadly, the sidecar module 207 can be considered an extension of the core module and internal compartment. That is, the sidecar 207 can receive modular devices typically housed within the internal compartment such as printers, and can also receive interface devices exemplified above. By providing the sidecar 207 in this way, the needs and functionality required by a customer or user can be further met, despite limitations of the size of the modular article or core module.

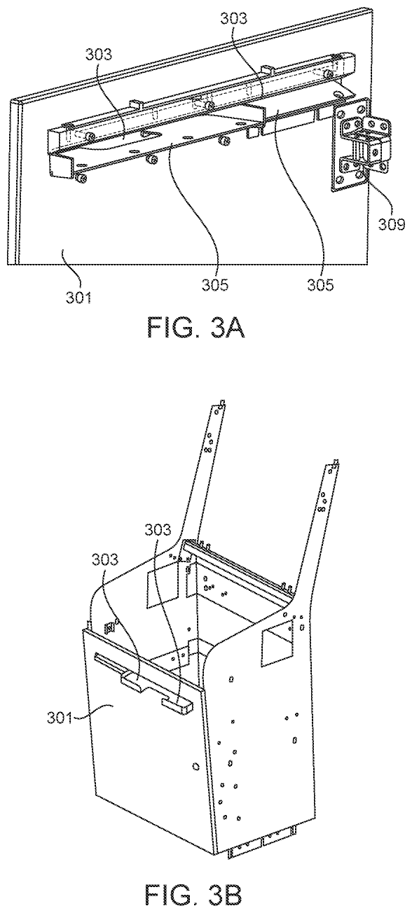

The modular article also comprises a door 301 to the internal compartment. The door 301 is coupled to the core module by a hinge mechanism 309 and is illustrated in more detail in FIG. 3A. The door 301 is configurable to comprise at least one aperture 303, for facilitating the use of the modular devices housed in the internal compartment. Specifically, the apertures 303 are configurable by arranging one or more insert portions 305 in order to provide an aperture configuration. A desired aperture configuration may correspond to the modules housed in the internal compartment. In particular, the apertures 303 may correspond to the printers installed, thereby facilitating dispensing from the printers to a user of the modular article.

FIG. 3B illustrates the door 301 coupled to the core module and in a closed position. In this example, the door is secured in a closed position by a securing mechanism. The door 301 covers the internal compartment housing modules and devices, and may be conveniently opened to replace, service, or maintain any housed devices or modules by unlocking the securing mechanism and pivoting the door about a hinge 309.

FIG. 4A illustrates the modular article with a device shelf 401, as well as alternative device shelves 405. The modular article 401 may initially comprise a device shelf configured to receive modular interface devices as exemplified above. The device shelf 401 may then be replaced with a device shelf 405 having a different configuration, depending on the needs or requirements of a particular customer or user. In addition, as technology needs to be updated or replaced, or particular devices need to be updated or replaced, a differently configured device shelf may be installed to receive such updated devices.

The second portion, and in particular the device shelf, is substantially arranged at an angle close to horizontal, but not horizontal, for example an angle of 81.5 degrees to the vertical.

The device shelf 401 is coupled to the core module by a locking mechanism 403. The locking mechanism comprises a smart releasable mechanism with a screw 409 at each side of the mechanism positioned towards the front of the modular article, allowing the device shelf 401 to be conveniently interchanged for a differently configured device shelf 405.

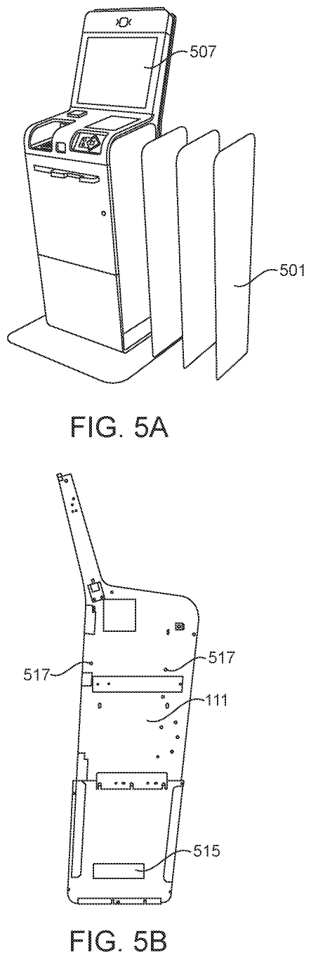

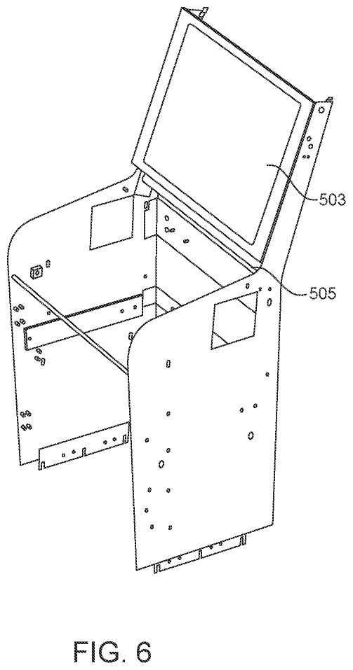

FIG. 5A illustrates a modular article, as well as interchangeable side panel layers 501. The core module has releasable attachment means 517 which can be used to couple a side panel layer 501 in the form of, for example, an advertisement or branding panel to the core module. A side panel layer 501 is coupled to the modular article using the releasable attachment means 517, and can be conveniently removed and replaced by releasing the releasable attachment means 517. The releasable attachment means 517 may be, for example, quick release screws. Whilst side panels layers coupling to only one side of the modular article are illustrated, it will be appreciated that side panel layers may be coupled to either side panel of the core module.

Attachment of the side panel layer is made more secure by a groove or protrusions at or towards the base of the side panels 111 as illustrated in FIG. 5B. A groove 515 is provided towards the base of each of the side panels 111, and the side panel layer is configured to slot into the groove. Once in this position, the side panel layer is secured to the modular article using the releasable attachment means 517. The side panel layer is configured such that, when inserted into the groove or protrusion, the groove or protrusion cannot be seen externally.

FIG. 6 illustrates a modular article and particularly the second portion of the interface portion. The second portion comprises an interface device, which in this example is a display, and specifically a touch screen display 503. The touch screen display is mounted to a face portion of the second portion and coupled to the core module via a hinge mechanism 505. The hinge mechanism is positioned at the base of the display 503 and allows the display 503 and face portion to pivot outwards away from the core module about its base. By doing so, convenient access behind the display is provided, allowing for servicing, maintenance, or installation of devices or modules including the display itself.

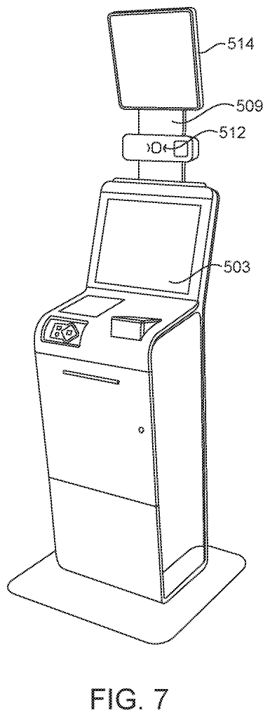

FIG. 7 illustrates a modular article having an extension portion 509 extending the second portion of the interface portion. The extended portion 509 provides an extension of the functionality of the interface portion, and particularly the second portion. In this example, the second portion comprises the display 503 as illustrated in FIG. 6. However, additionally, the extended portion 509 further comprises a camera 512 and an external camera flash 514. The extended portion illustrated is of a particular height. It will be appreciated that differently configured extended portions having the same or different devices or modules, with the same or different heights may alternatively be coupled to the second portion depending on the particular requirements of a customer or user.

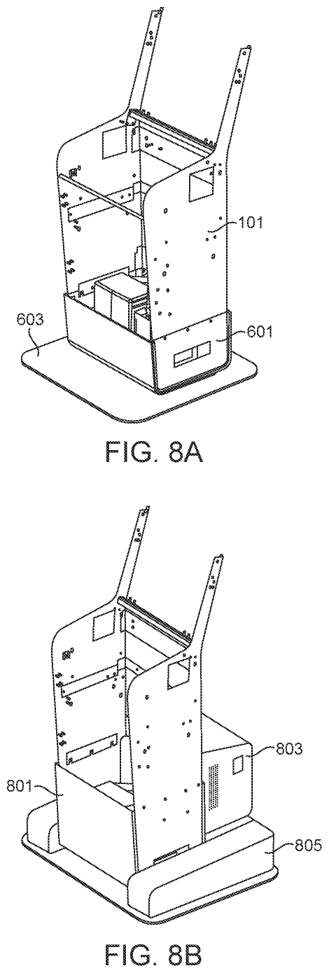

FIG. 8A illustrates a modular article having a core module 101 coupled to a base portion 601. The base portion 601 is configured to receive base modules, providing further functionality to the modular article. In this example, the base module includes a stability plate 603. The stability plate 603 has a surface area significantly larger than the base of the core module and modular article, therefore providing the modular article with significantly better stability.

Whilst the only base module illustrated in FIG. 8A is the stability plate 603, it will be appreciated that various other configurations of base modules may be provided. For example, FIG. 8B illustrates an alternatively configured base portion 801 comprising a battery pack 803 configured to provide power to the modular article, removing the need for a connection to an external power source, and a mobility module 805 for relocating or moving the modular article. In some embodiments, the base modules may additionally or alternatively include an adapter module to enable the modular article to adapt to a legacy connection point.

In addition, the base portion 601 illustrated in FIG. 8A provides an increase in height of the modular article. That is, the core module is mounted to the base portion 601 which itself has a height. The base portion 801 illustrated in FIG. 8B provides a greater increase in height. It will be appreciated that base portions having a smaller or greater height may be coupled to the core module, decreasing or increasing the height respectively. Such an adjustment may enable the modular article to meet particular regulations. The base portion 601 illustrated in FIG. 8A, for example, may meet ADA requirements. That is, to meet

ADA requirements, all components potentially requiring interaction with a user may need to be below a particular height. The base portion may have a height such that this is the case.

In practice, a user or customer may be provided with a modular article having any of the features described herein, but may for example comprise the core module, the interface portion, and in some cases the door to the internal compartment. A method of modifying such a modular article may then be carried out. The method comprises mounting or installing one or more of: an internal module, a modular device, and a modular interface device to the modular article.

Broadly, the modular article disclosed provides a structure configured to receive modules and devices, and is capable of having those modules and devices replaced, upgraded, modified, serviced, or maintained, by virtue of the modular articles' modularity. A method of modifying the modular article may therefore comprise the installation of any described module or device, and/or the replacement, upgrade, modification, servicing, or maintenance of any such module or device. Such flexibility removes the need for replacement of the entire article or kiosk when only a particular aspect of the kiosk is to be modified in some way.

Embodiments of the present invention have been described. It will be appreciated that variations and modifications may be made to the described embodiments within the scope of the present invention.

1. A modular article (100) comprising:
a core module (101) including: a back panel (103) and an internal compartment (105) configured to house one or more internal modules and one or more modular devices (107);
a door (301) to the internal compartment coupled to the core module (101) and being configurable to comprise at least one aperture (303) configured to facilitate use of the one or more modular devices (107) in the internal compartment (105); and
an interface portion coupled to the core module, the interface portion having a first portion (201) and a second portion (203), each of the first portion (201) and the second portion (203) being configured to receive one or more modular interface devices (205).

2. A modular article according to claim 1 wherein the core module (101) and the interface portion comprise a plurality of connection means (109), the one or more modular devices (107) and the one or more modular interface devices (205) being configured to be releasably securable to the plurality of connection means (109).

3. A modular article according to claim 2 wherein the core module (101) further comprises side panels (111) forming sides of the internal compartment (105).

4. A modular article according to claim 3 wherein each of the side panels (111) comprises at least one releasable attachment point (113) configured to releasably attach a side panel layer (501) to one or each of the side panels (111).

5. A modular article according to claim 3 or claim 4 further comprising a sidecar module (207) releasably attachable to one of the side panels.

6. A modular article according to claim 5 wherein the sidecar module (207) is configured to receive one or more modular devices and/or one or more modular interface devices.

7. A modular article according to any of claims 3 to 6 wherein the core module (101) further comprises cross members (115) arranged between the side panels (111), the cross members (115) comprising at least some of the plurality of connection means (109).

8. A modular article according to any proceeding claim wherein the door (301) is configurable to comprise the at least one aperture (303) by arranging one or more removable insert portions (305) to provide an aperture configuration.

9. A modular article according to any preceding claim wherein the first portion (201) comprises an interface device shelf (401) configured to receive at least one of the one or more modular interface devices (205), the device shelf (401) being releasably coupled to the core module (101).

10. A modular article according to claim 9 wherein the device shelf (401) is releasably coupled to the core module (101) with a locking mechanism (403).

11. A modular article according to claim 9 or claim 10 wherein the device shelf (401) is interchangeable with one or more device shelves (405) having different configurations to facilitate different configurations of modular interface devices.

12. A modular article according to any proceeding claim wherein the first portion (201) is nearly, but is not, horizontal.

13. A modular article according to any proceeding claim wherein the one or more modular devices (107) housed in the internal compartment comprises one or more dispensing means.

14. A module article according to claim 13 wherein the one or more dispensing means comprises one or more of: a boarding pass printer; a bag tag printer; and a receipt printer.

15. A modular article according to any preceding claim wherein the second portion (203) comprises a face portion (503) and a hinge mechanism (505) configured to allow opening and closing of the face portion (503).

16. A modular article according to claim 15 wherein the one or more modular interface devices comprises a display (507) coupled to the core module (101) via the hinge mechanism (505).

17. A modular article further comprising a base portion (601) coupled to the core module (101), the base portion (601) being configured to support the core module and to receive one or more base modules (603).

18. A modular article according to claim 17 wherein the one or more base modules comprises one or more of: a battery pack; a mobility module; a stability plate; and an adapter module.

19. A modular article according to any proceeding claim wherein the one or more internal modules comprises a processor configured to identify and control the one or more internal modules, the one or more modular devices (107), and the one or more modular interface devices (205).

20. A modular article according to any preceding claim wherein the modular article is a kiosk.

21. A modular article according to any preceding claim wherein the one or more internal modules comprises one or more computer modules.

22. A modular article according to any preceding claim wherein the one or more modular interface devices comprise one or more of: a passport scanner; a display;
payment means; a card reader; a pin pad; a near field communication (NFC) reader; a barcode reader; a fingerprint scanner; a lighting device; one or more cameras; directional buttons; selection buttons; and an audio jack input.

23. A method of modifying a modular article comprising:
providing a modular article according to claim 1; and
mounting or installing one or more of: an internal module, a modular device, and a modular interface device to the modular article.

24. A method of modifying a modular article according to claim 23 wherein the core module and the interface portion comprise a plurality of connection means, and the mounting or installing comprises releasably securing one or more of: the modular device, and the modular interface device to at least some of the connection means.

25. A method of modifying a modular article according to claim 24 wherein the core module further comprises side panels forming sides of the internal compartment.

26. A method of modifying a modular article according to claim 25 wherein each of the side panels comprises at least one releasable attachment point, and the method further comprises releasably attaching one or more of: a sidecar module; and a side panel layer to one or each of the side panels.

27. A method of modifying a modular article according to claim 26 further comprising mounting or installing one or more modular devices and/or one or more modular interface devices to the sidecar module.

28. A method of modifying a modular article according to any of claims 25 to 27 wherein the core module further comprises cross members arranged between the side panels, the cross members comprising at least some of the plurality of connection means, and the method further comprises mounting or installing the one or more modular devices to the plurality of connection means of the cross members.

29. A method of modifying a modular article according to any of claims 23 to 28 further comprising arranging one or more insert portions at the least one aperture to provide an aperture configuration.

30. A method of modifying a modular article according to any of claims 23 to 29 wherein the first portion comprises an interface device shelf releasably coupled to the core module, and the method further comprises mounting or installing the one or more modular interface devices to the interface device shelf.

31. A method of modifying a modular article according to claim 30 wherein the device shelf is releasably coupled to the core module with a locking mechanism.

32. A method of modifying a modular article according to claim 30 or claim 31 further comprising replacing the device shelf with a differently configured device shelf configured to facilitate a different configuration of modular interface devices.

33. A method of modifying a modular article according to any of claims 23 to 32 wherein the one or more modular devices housed in the internal compartment comprises one or more dispensing means.

34. A method of modifying a modular article according to claim 33 wherein the one or more dispensing means comprises one or more of: a boarding pass printer; a bag tag printer; and a receipt printer.

35. A method of modifying a modular article according to any of claims 23 to 34 wherein the second portion comprises a face portion and a hinge mechanism configured to allow opening and closing of the face portion, the method further comprising opening the face portion via the hinge to modify or install one or more modular interface devices.

36. A method of modifying a modular article according to claim 35 wherein the one or more modular interface devices comprises a display coupled to the core module via the hinge mechanism.

37. A method of modifying a modular article according to any of claims 23 to 36 further comprising coupling a base portion to the core module.

38. A method of modifying a modular article according to claim 37 further comprising mounting or installing one or more base modules to the base portion.

39. A method of modifying a modular article according to claim 38 wherein the one or more base modules comprise one or more of: a battery pack; a mobility module; a stability plate; and an adapter module.

40. A method of modifying a modular article according to any of claims 23 to 39 wherein the one or more internal modules comprises a processor configured to identify and control the one or more internal modules, the one or more modular devices, and the one or more modular interface devices.

41. A method of modifying a modular article according to any of claims 23 to 40 wherein the modular article is a kiosk.

42. A method of modifying a modular article according to any of claims 23 to 41 wherein the one or more internal modules comprises one or more computer modules.

43. A modular article according to any of claims 23 to 42 wherein the one or more modular interface devices comprises one or more of: a passport scanner; a display; payment means; a card reader; a pin pad; a near field communication (NFC) reader; a barcode reader; a fingerprint scanner; a lighting device; one or more cameras; directional buttons; selection buttons; and an audio jack input.
